(19) United States
(12) Patent Application Publication
(10) Pub. No.: US 2017/0223741 A1
(43) Pub. Date: Aug. 3, 2017

(54) EFFICIENT CLEAR CHANNEL ASSESSMENT (CCA) WITH REQUEST-TO-SEND (RTS) FRAME AND CLEAR-TO-SEND (CTS) FRAME

(71) Applicant: QUALCOMM Incorporated, San Diego, CA (US)

(72) Inventors: Alecsander Petru EITAN, Haifa (IL); Amichai SANDEROVICH, Atlit (IL); Gal BASSON, Haifa (IL)

(21) Appl. No.: 15/421,051

(22) Filed: Jan. 31, 2017

Related U.S. Application Data
(60) Provisional application No. 62/290,687, filed on Feb. 3, 2016.

(51) Int. Cl. H04W 74/08

(52) U.S. Cl. CPC H04W 74/0816; H04W 84/12

(57) ABSTRACT

Certain aspects of the present disclosure provide an apparatus for wireless communication. The apparatus may generally include a first interface configured to obtain a first frame on at least one channel, a processing system configured to perform an assessment on the at least one channel, and generate a second frame after obtaining the first frame, and determine a transmission time of the second frame based on results of the assessment, and a second interface configured output the second frame for transmission on the at least one channel according to the determined transmission time.

### CLAIM OF PRIORITY UNDER 35 U.S.C. §119

The present application claims the benefit of U.S. Provisional Patent Application Ser. No. 62/290,687, entitled “EFFICIENT CLEAR CHANNEL ASSESSMENT (CCA) WITH REQUEST-TO-SEND (RTS) FRAME AND CLEAR-TO-SEND (CTS) FRAME” and filed Feb. 3, 2016, which is assigned to the assignee of the present application and hereby expressly incorporated by reference herein in its entirety.

### FIELD

Certain aspects of the present disclosure generally relate to wireless communications and, more particularly, to performing channel assessment.

### BACKGROUND

In order to address the issue of increasing bandwidth requirements demanded for wireless communications systems, different schemes are being developed to allow multiple user terminals to communicate with a single access point by sharing the channel resources while achieving high data throughputs. Multiple-input multiple-output (MIMO) technology represents one such approach that has recently emerged as a popular technique for next generation communication systems. MIMO technology has been adopted in several emerging wireless communications standards, such as the Institute of Electrical and Electronics Engineers (IEEE) 802.11 standard. The IEEE 802.11 standard denotes a set of Wireless Local Area Network (WLAN) air interface standards developed by the IEEE 802.11 committee for short-range communications (e.g., tens of meters to a few hundred meters).

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

In wireless networks with a single Access Point (AP) and multiple user stations (STAs), concurrent transmissions may occur on multiple channels toward different stations, both in the uplink and downlink direction. Many challenges are present in such systems.

### SUMMARY

Certain aspects of the present disclosure provide an apparatus for wireless communication. The apparatus may generally include a first interface configured to obtain a first frame on at least one channel, and a processing system configured to perform an assessment on the at least one channel and generate a second frame in response to the first frame, determine a transmission time of the second frame based on results of the assessment, and a second interface configured output the second frame for transmission on the at least one channel according to the determined transmission time.

Certain aspects of the present disclosure provide an apparatus for wireless communication. The apparatus generally includes a processing system configured to generate a first frame, a first interface configured to output for transmission the first frame on at least one channel, and a second interface configured obtain a second frame on the at least one channel after outputting for transmission the first frame, wherein the processing system is further configured to determine whether the second frame comprises an indication that the second frame is a last transmission in response to the first frame, and defer a data transmission based on the determination.

Certain aspects of the present disclosure provide a method for wireless communication. The method generally includes obtaining a first frame on at least one channel, performing an assessment on the at least one channel, generating a second frame after obtaining the first frame, determining a transmission time of the second frame based on results of the assessment, and outputting the second frame for transmission on the at least one channel according to the determined transmission time.

Certain aspects of the present disclosure provide a method for wireless communication. The method generally includes generating a first frame, outputting the first frame for transmission on at least one channel, obtaining a second frame on the at least one channel after outputting the first frame, determining whether the second frame comprises an indication that the second frame is a last transmission in response to the first frame, and deferring outputting data for transmission based on the determination.

Certain aspects of the present disclosure provide an apparatus for wireless communication. The apparatus generally includes means for obtaining a first frame on at least one channel, means for performing an assessment on the at least one channel, and means for generating a second frame after obtaining the first frame, and means for determining a transmission time of the second frame based on results of the assessment, and means for outputting the second frame for transmission on the at least one channel according to the determined transmission time.

Certain aspects of the present disclosure provide an apparatus for wireless communication. The apparatus generally includes means for generating a first frame, means for outputting for transmission the first frame on at least one channel, means for obtaining a second frame on the at least one channel after outputting for transmission the first frame, means for determining whether the second frame comprises an indication that the second frame is a last transmission in response to the first frame, and means for deferring a data transmission based on the determination.

Certain aspects of the present disclosure provide a computer-readable medium having instructions stored thereon for obtaining a first frame on at least one channel, performing an assessment on the at least one channel, generating a second frame after obtaining the first frame, determining a transmission time of the second frame based on results of the assessment, and outputting the second frame for transmission on the at least one channel according to the determined transmission time.

Certain aspects of the present disclosure provide a computer-readable medium having instructions stored thereon for generating a first frame, outputting for transmission the first frame on at least one channel, obtaining a second frame on the at least one channel after outputting for transmission the first frame, determining whether the second frame comprises an indication that the second frame is a last transmission in response to the first frame, and deferring a data transmission based on the determination.

Certain aspects of the present disclosure provide a wireless node. The wireless node generally includes at least one antenna, a receiver configured to receive, via the at least one antenna, a first frame on at least one channel, a processing system configured to perform an assessment on the at least one channel, and generate a second frame after receiving the first frame, and determine a transmission time of the second frame based on results of the assessment, and a transmitter configured transmit the second frame on the at least one channel according to the determined transmission time.

Certain aspects of the present disclosure provide a wireless node. The wireless node generally includes at least one antenna, a processing system configured to generate a first frame, a transmitter configured to transmit, via the at least one antenna, the first frame on at least one channel, and a receiver configured to receive, via the at least one antenna, a second frame on the at least one channel after transmission of the first frame, wherein the processing system is further configured to determine whether the second frame comprises an indication that the second frame is a last transmission in response to the first frame, and defer a data transmission based on the determination.

### BRIEF DESCRIPTION OF THE DRAWINGS

FIG. 1 is a diagram of an example wireless communications network, in accordance with certain aspects of the present disclosure.

FIG. 2 is a block diagram of an example access point and example user terminals, in accordance with certain aspects of the present disclosure.

FIG. 3 illustrates an example wireless device, in accordance with certain aspects of the present disclosure.

FIGS. 4A and 4B are example timing diagrams of RTS and CTS transmissions.

FIG. 5 illustrates example operations for wireless communication from a perspective of a responding device, in accordance with certain aspects of the present disclosure.

FIG. 5A illustrates example means capable of performing the operations shown in FIG. 5.

FIG. 6 illustrates example operations for wireless communication form a perspective of an initiating device, in accordance with certain aspects of the present disclosure.

FIG. 6A illustrates example means capable of performing the operations shown in FIG. 6.

FIG. 7 is an example timing diagram of RTS and CTS transmissions with channel bonding (CB), in accordance with certain aspects of the present disclosure.

FIGS. 8A and 8B are example timing diagrams of RTS and CTS transmissions with CB, in accordance with certain aspects of the present disclosure.

### DETAILED DESCRIPTION

Certain aspects of the present disclosure provide techniques for performing clear channel assessment (CCA) for clear-to-send (CTS) transmissions with channel bonding (CB). For example, an initiating device may transmit a ready-to-send (RTS) frame to a responding device, from which a corresponding CTS frame is to be received. The RTS frame may be transmitted on a plurality of channels in accordance with CB. A time period at which the corresponding CTS frame may be transmitted by the responding device may depend on whether the responding station has sufficient CCA information.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. An SDMA system may utilize sufficiently different directions to simultaneously transmit data belonging to multiple stations. A TDMA system may allow multiple stations to share the same frequency channel by dividing the transmission signal into different time slots, each time slot being assigned to different stations. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA” such as an “AP STA” acting as an AP or a “non-AP STA”) or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the AT may be a wireless node. Such wireless node may provide, for example, connectivity for or to a network (e.g., a wide area network such as the Internet or a cellular network) via a wired or wireless communication link.

### An Example Wireless Communication System

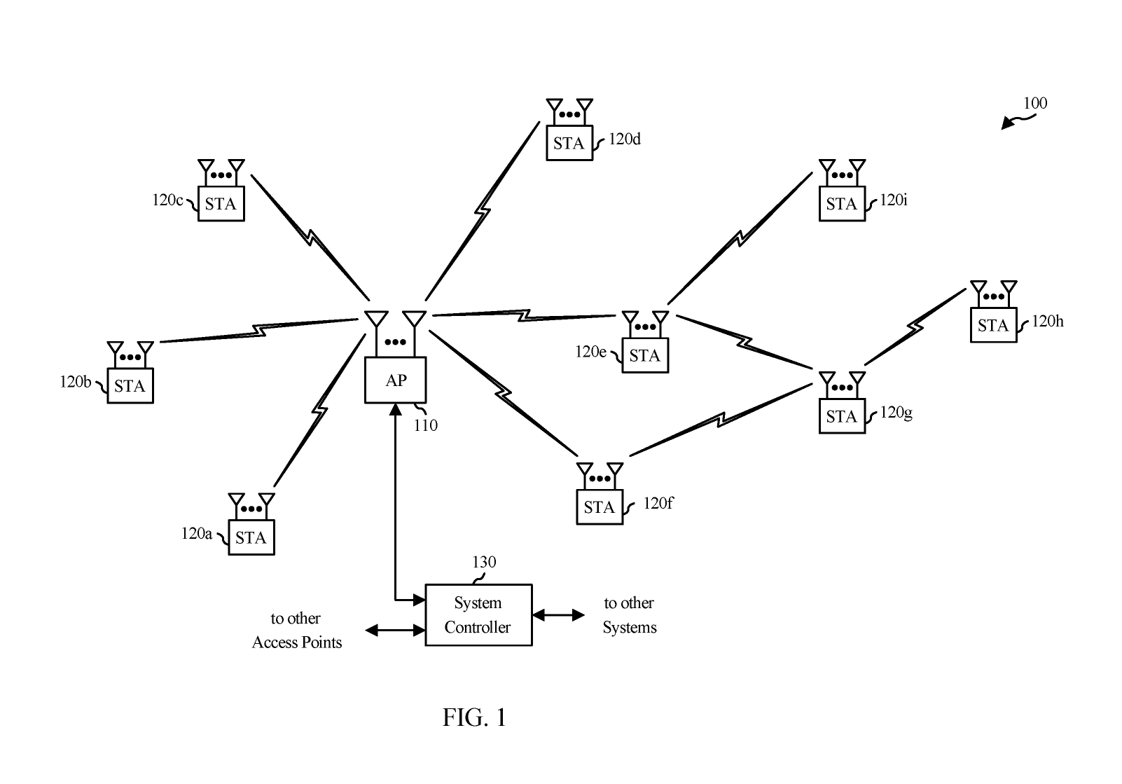

FIG. 1 illustrates a system 100 in which aspects of the disclosure may be performed. For example, an access point 120 may perform beamforming training to improve signal quality during communication with a station (STA) 120. The beamforming training may be performed using a MIMO transmission scheme.

The system 100 may be, for example, a multiple-access multiple-input multiple-output (MIMO) system 100 with access points and stations. For simplicity, only one access point 110 is shown in FIG. 1. An access point is generally a fixed station that communicates with the stations and may also be referred to as a base station or some other terminology. A STA may be fixed or mobile and may also be referred to as a mobile station, a wireless device, or some other terminology. Access point 110 may communicate with one or more STAs 120 at any given moment on the downlink and uplink. The downlink (i.e., forward link) is the communication link from the access point to the STAs, and the uplink (i.e., reverse link) is the communication link from the STAs to the access point. A STA may also communicate peer-to-peer with another STA.

A system controller 130 may provide coordination and control for these APs and/or other systems. The APs may be managed by the system controller 130, for example, which may handle adjustments to radio frequency power, channels, authentication, and security. The system controller 130 may communicate with the APs via a backhaul. The APs may also communicate with one another, e.g., directly or indirectly via a wireless or wireline backhaul.

While portions of the following disclosure will describe STAs 120 capable of communicating via Spatial Division Multiple Access (SDMA), for certain aspects, the STAs 120 may also include some STA that do not support SDMA. Thus, for such aspects, an AP 110 may be configured to communicate with both SDMA and non-SDMA STAs. This approach may conveniently allow older versions of STAs (“legacy” stations) to remain deployed in an enterprise, extending their useful lifetime, while allowing newer SDMA STAs to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected STAs 120 collectively represents the multiple-output for downlink transmissions and the multiple-input for uplink transmissions. For pure SDMA, it is desired to have Nₐₚ K 1 if the data symbol streams for the K STAs are not multiplexed in code, frequency or time by some means. K may be greater than Nₐₚ if the data symbol streams can be multiplexed using TDMA technique, different code channels with CDMA, disjoint sets of subbands with OFDM, and so on. Each selected STA transmits user-specific data to and/or receives user-specific data from the access point. In general, each selected STA may be equipped with one or multiple antennas (i.e., Nᵤₜ≧1). The K selected STAs can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each STA may be equipped with a single antenna (e.g., in order to keep costs down) or multiple antennas (e.g., where the additional cost can be supported). The system 100 may also be a TDMA system if the STAs 120 share the same frequency channel by dividing transmission/reception into different time slots, each time slot being assigned to different STA 120.

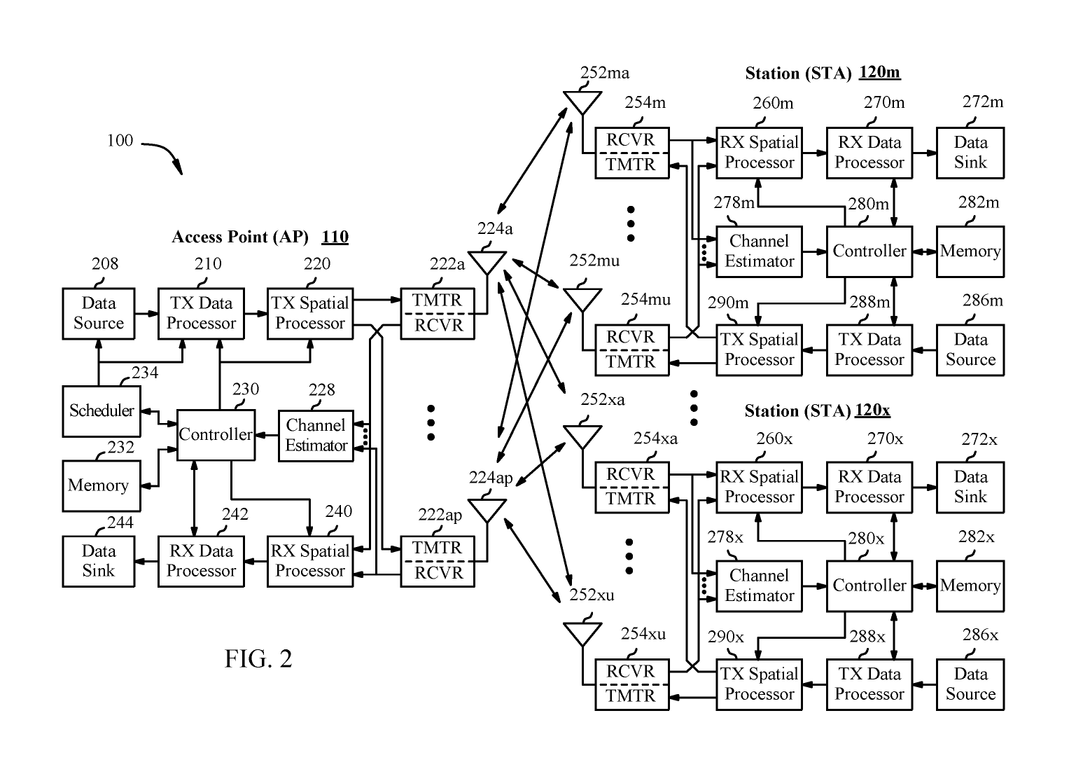

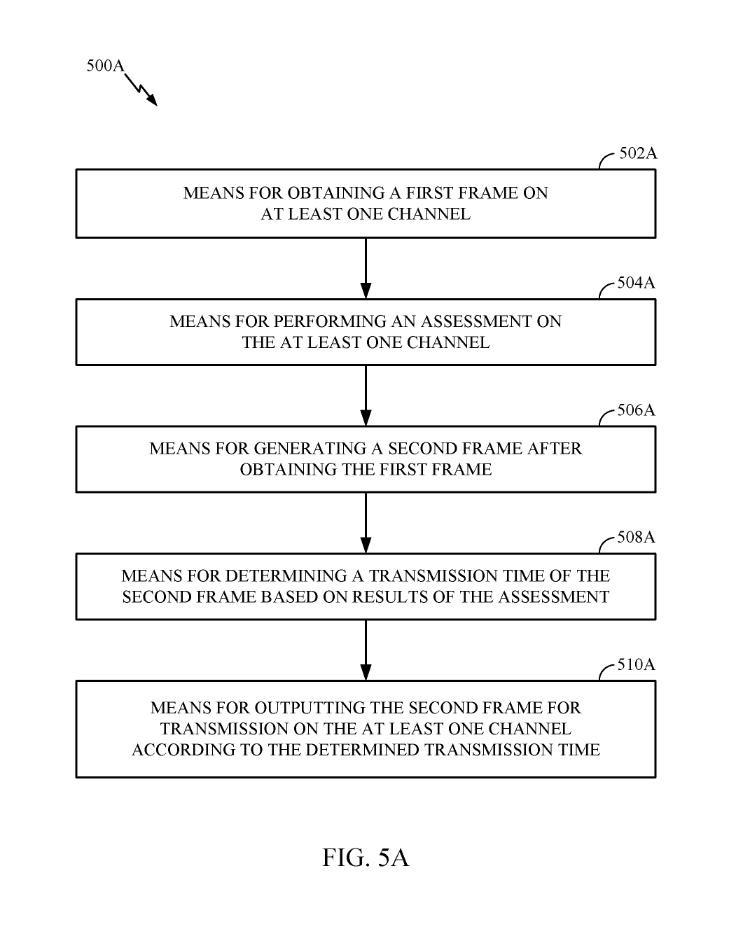

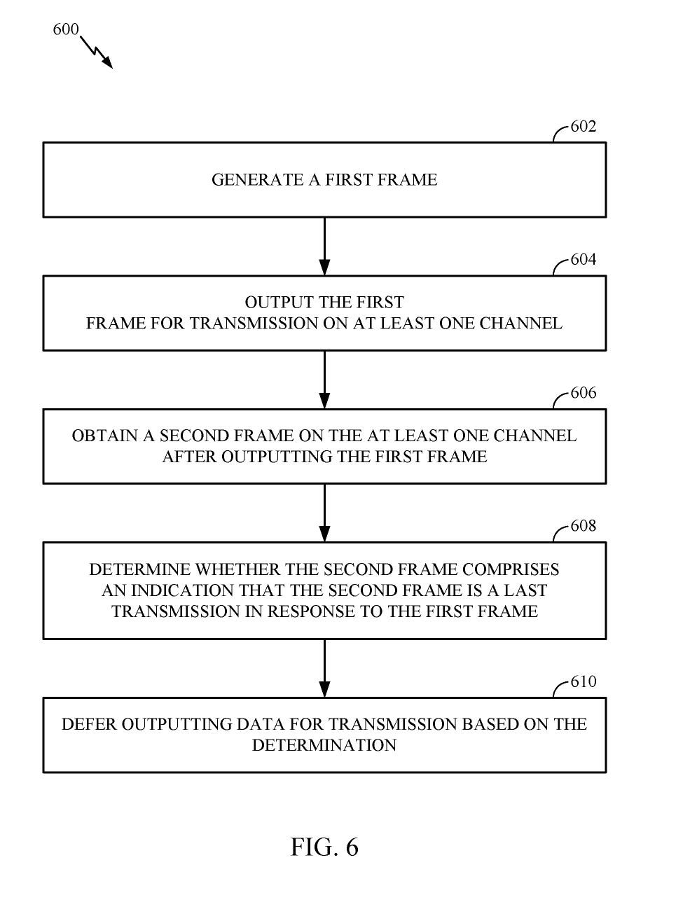

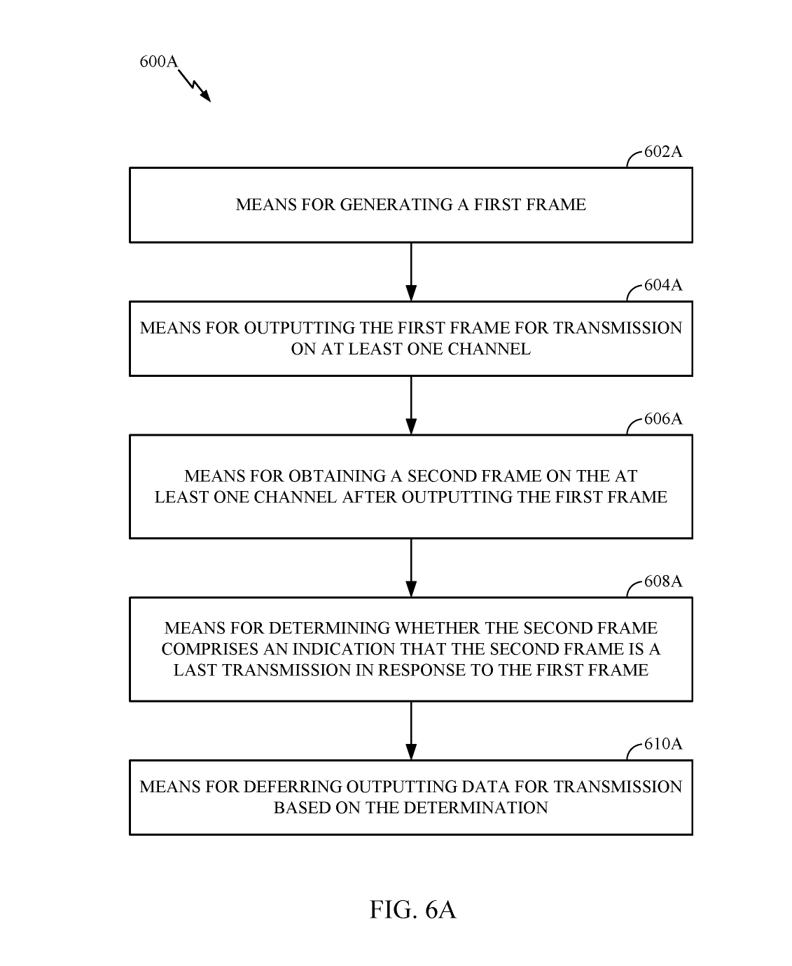

FIG. 2 illustrates example components of the AP 110 and UT 120 illustrated in FIG. 1, which may be used to implement aspects of the present disclosure. One or more components of the AP 110 and UT 120 may be used to practice aspects of the present disclosure. For example, antenna 224, Tx/Rx 222, processors 210, 220, 240, 242, and/or controller 230 or antenna 252, Tx/Rx 254, processors 260, 270, 288, and 290, and/or controller 280 may be used to perform the operations described herein and illustrated with reference to FIGS. 5 and 5A, and FIGS. 6 and 6A.

FIG. 2 illustrates a block diagram of access point 110 two STAs 120m and 120x in a MIMO system 100. The access point 110 is equipped with Nₜ antennas 224a through 224ap. STA 120m is equipped with N_{ut,m} antennas 252ma through 252mu, and STA 120x is equipped with N_{ut,x} antennas 252xa through 252xu. The access point 110 is a transmitting entity for the downlink and a receiving entity for the uplink. Each STA 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ STA are selected for simultaneous transmission on the uplink, N_{dn} STAs are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and STA.

On the uplink, at each STA 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the STA based on the coding and modulation schemes associated with the rate selected for the STA and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ STAs may be scheduled for simultaneous transmission on the uplink. Each of these STAs performs spatial processing on its data symbol stream and transmits its set of transmit symbol streams on the uplink to the access point.

At access point 110, Nₐₚ antennas 224a through 224ap receive the uplink signals from all Nᵤₚ STAs transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective STA. An RX data processor 242 processes (e.g., demodulates, deinterleaves, and decodes) each recovered uplink data symbol stream in accordance with the rate used for that stream to obtain decoded data. The decoded data for each STA may be provided to a data sink 244 for storage and/or a controller 230 for further processing. The controller 230 may be coupled with a memory 232.

On the downlink, at access point 110, a TX data processor 210 receives traffic data from a data source 208 for N_{dn} STAs scheduled for downlink transmission, control data from a controller 230, and possibly other data from a scheduler 234. The various types of data may be sent on different transport channels. TX data processor 210 processes (e.g., encodes, interleaves, and modulates) the traffic data for each STA based on the rate selected for that STA. TX data processor 210 provides N_{dn} downlink data symbol streams for the N_{dn} STAs. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the STAs. The decoded data for each STA may be provided to a data sink 272 for storage and/or a controller 280 for further processing.

At each STA 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the STA. The receiver spatial processing is performed in accordance with the CCMI, MMSE or some other technique. An RX data processor 270 processes (e.g., demodulates, deinterleaves and decodes) the recovered downlink data symbol stream to obtain decoded data for the STA.

At each STA 120, a channel estimator 278 estimates the downlink channel response and provides downlink channel estimates, which may include channel gain estimates, SNR estimates, noise variance and so on. Similarly, at access point 110, a channel estimator 228 estimates the uplink channel response and provides uplink channel estimates. Controller 280 for each STA typically derives the spatial filter matrix for the STA based on the downlink channel response matrix H_{dn,m} for that STA. Controller 230 derives the spatial filter matrix for the access point based on the effective uplink channel response matrix H_{up,eff}. Controller 280 for each STA may send feedback information (e.g., the downlink and/or uplink eigenvectors, eigenvalues, SNR estimates, and so on) to the access point. Controllers 230 and 280 also control the operation of various processing units at access point 110 and STA 120, respectively.

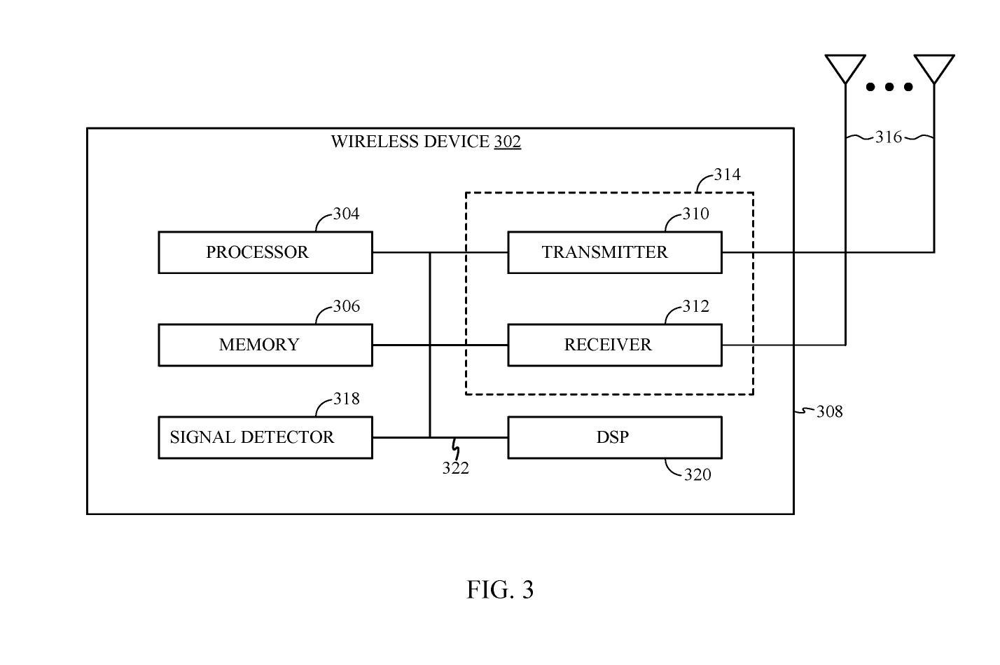

FIG. 3 illustrates various components that may be utilized in a wireless device 302 that may be employed within the MIMO system 100. The wireless device 302 is an example of a device that may be configured to implement the various methods described herein. For example, the wireless device may implement operations 500 and 600 illustrated in FIGS. 5 and 6, respectively. The wireless device 302 may be an access point 110 or a STA 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote node. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

### Example Technique for Clear Channel Assessment (CCA)

In the IEEE 802.11ay standard (e.g., using 60 GHz frequency band), an initiating device may send a request-to-send (RTS) frame over multiple channels for channel bonding (CB), including a primary channel and one or more secondary channels. A responding device may listen to all of the channels or it may listen to only the primary channel. A primary channel generally refers to a main channel when more than one channel is available and typically has the highest data rate of the available channels. In the former case, when sending a clear-to-send (CTS) frame after a short interframe space (SIFS) interval, the responding device may be unable to comply with clear channel assessment (CCA) rules to measure all channels for at least a point coordination function (PCF) interframe space (PIFS) interval.

The RTS and CTS may include a control trailer (CT). The CT is a trailer added to RTS or CTS frames to make room for additional bits since the RTS and CTS frames may not have spare bits. Certain aspects of the present disclosure may assume that the additional signaling is placed in the CT since no spare bits may be available in the RTS and CTS frames.

In previous standards, such as standards released prior to IEEE 802.11ay, an assumption was made that the receiver is open (e.g. receiving) on all channels. In the IEEE 802.11 ay standard, in order to save power, it is considered to allow the responding device to monitor just the primary channel. However, this may prevent the responding device from having updated CCA information on the non-primary channels.

One possible solution is to send a grant frame. However, the grant frame may take about 15.05 usec. Moreover, a PIFS interval may take about 8 usec, and in some cases, up to 18 usec, plus a switching time period. The RTS with CT frames may take 14.04 usec+2.84 usec. SIFS may take about 3 usec, and CTS with CT may take about 14.04 usec+2.84 usec. Thus, using the grant frame solution may waste a time period associated with the grant frame plus a time period associated with the PIFS interval, or roughly 23 usec or more. Certain aspects of the present disclosure provide a more efficient technique for performing CCA with CB.

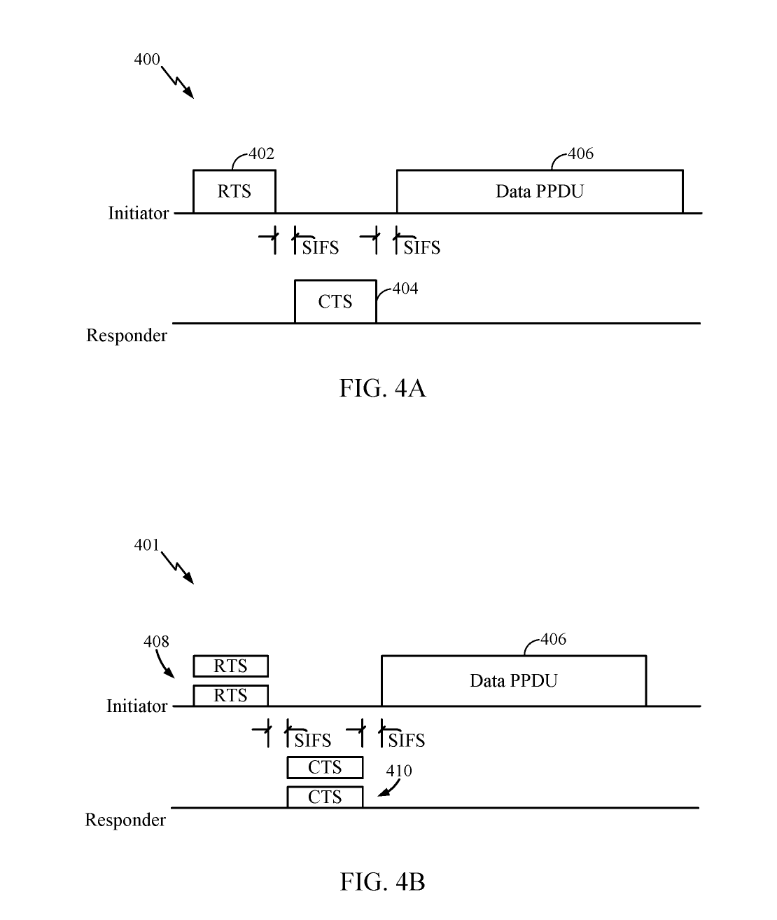

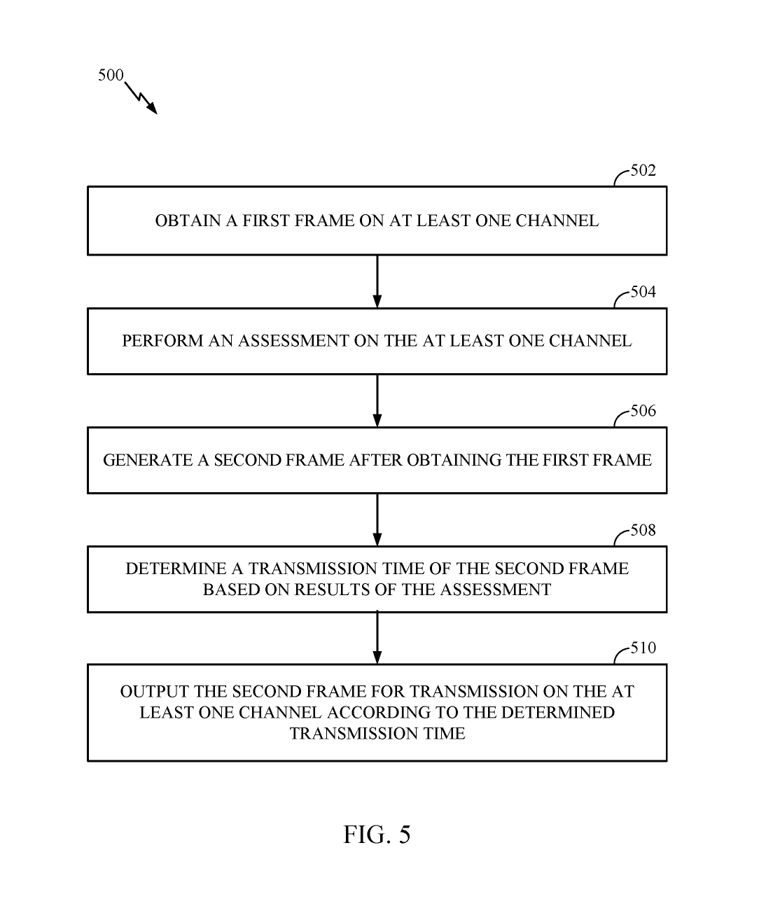

FIG. 4A is an example timing diagram 400 for transmission of RTS and CTS without CB. The IEEE 802.11 standard (e.g., REVmc Draft 5.0, and 802.11ad) specifies that the initiating device sends an RTS frame 402, and a responding device acknowledges via a CTS frame 404, after a SIFS interval. Then the responding device starts data transmission, for example, via a data physical layer convergence protocol (PLCP) protocol data unit (PPDU) 406, after a SIFS interval.

FIG. 4B is an example timing diagram 401 for transmission of RTS and CTS with CB. When CB is used, the RTS frame transmission 408 is sent by the initiating device on multiple channels, including a primary channel, and a CTS frame transmission 410 is sent by the responding device on the multiple channels in response to the RTS frame transmission 408. However, as presented above, the responding device may be unable to comply with CCA rules to measure all the channels for the CTS transmissions.

FIG. 5 illustrates example operations 500 for wireless communication, in accordance with aspects of the present disclosure. The operations 500 may be performed, for example, by a wireless node (hereinafter referred to as a responding device).

The operations 500 begin, at 502, by obtaining a first frame on at least one channel and, at 504, performing an assessment on the at least one channel. At 506, the responding device may generate a second frame after obtaining the first frame, and at 508, determine a transmission time of the second frame based on results of the assessment. At 510, the responding device may output the second frame for transmission on the at least one channel according to the determined transmission time. In certain aspects, the first frame may be an RTS frame, and the second frame may be a CTS frame. In certain aspects, the RTS frame may be obtained on a plurality of channels and the CTS frame may be output for transmission on the plurality of channels.

FIG. 6 illustrates example operations 600 for wireless communication, in accordance with aspects of the present disclosure. The operations 600 may be performed, for example, by a wireless node (hereinafter referred to as an initiating device).

The operations 600 begin, at 602, by generating a first frame and, at 604, outputting the first frame for transmission on at least one channel. At 606, the initiating device may obtain a second frame on the at least one channel after outputting the first frame, and at 608, determine whether the second frame comprises an indication that the second frame is a last transmission in response to the first frame. At 610, the initiating device may defer outputting data for transmission based on the determination.

In certain aspects, the first frame may be an RTS frame, and the second frame may be a CTS frame. In this case, the RTS frame may be output for transmission on a plurality of channels and the CTS frame may be obtained on the plurality of channels.

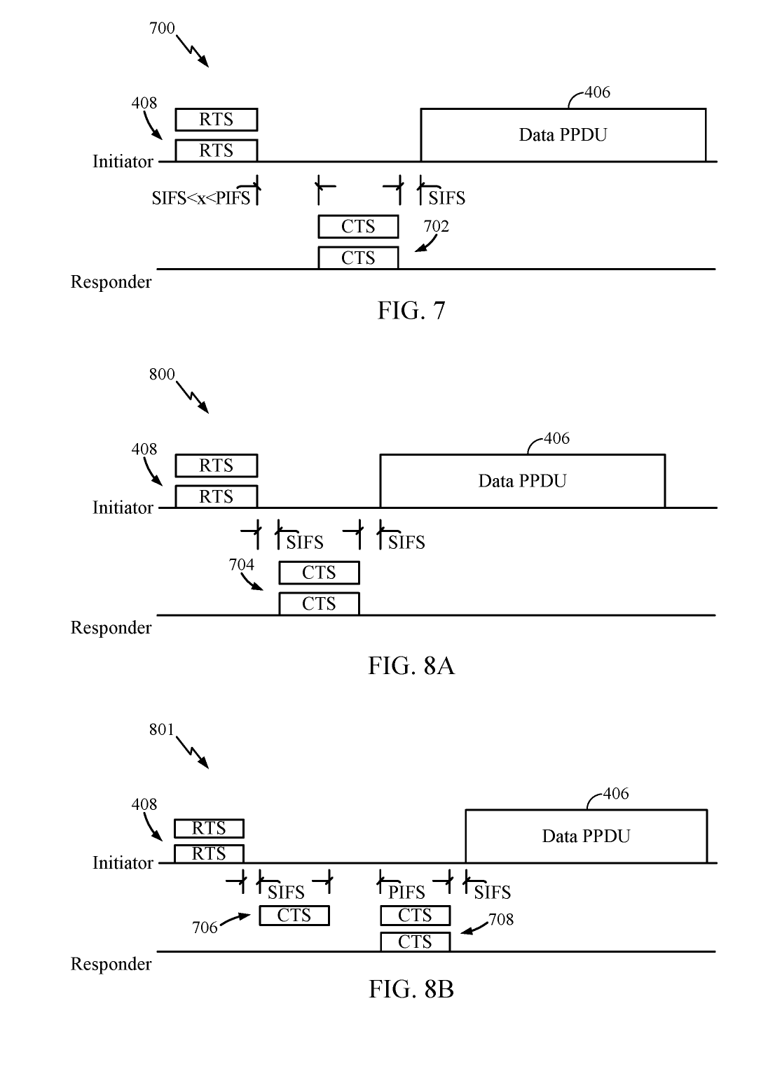

FIG. 7 illustrates a timing diagram 700 for transmission of RTS and CTS frames with CB, in accordance with certain aspects of the present disclosure. As illustrated, the CTS frame transmission 702 may be transmitted on multiple channels, including a primary channel, after a variable time period. The variable time period may be between an inter-frame time for SIFS and PIFS after the RTS frame is received by the responding device. Thus, the responding device may be allowed to vary a transmission time of the CTS frame transmission 702 based on availability of CCA information. This technique allows for the responding device to listen on the primary channel and may have little to no overhead if the responding device has CCA already measured. The maximum time between reception of the RTS frame transmission 408 and the CTS frame transmission 702 may be slightly larger than the PIFS interval due to switching time, which may be less than 1 usec. In certain aspects, the RTS frame transmission 408 and CTS frame transmission 702 may include a CT.

FIGS. 8A and 8B illustrates timing diagrams 800 and 801 for transmission of RTS and CTS frames with CB, in accordance with certain aspects of the present disclosure. In certain aspects, an initiating device may send RTS frame transmission 408 (e.g., with or without CT) and the responding device may answer after a SIFS interval with one of the two options, as discussed with respect to FIGS. 8A and 8B.

As illustrated in FIG. 8A, if the responding device already has CCA information, it may answer with a CTS frame transmission 704 (e.g., with or without CT) on all the requested channels, acknowledging the RTS frame transmission 408 by the initiating device. In certain aspects, all CTS frames transmitted (with or without CT) may indicate to the initiating device that the CTS frame is final. That is, CTS frame may indicate that the CTS frame transmission is the last CTS frame transmission in response to the RTS frame transmission 408 and that the initiating device may proceed with data transmission. However, if one or more channels are not free (e.g., based on CCA) then the responding device may not send a CTS frame transmission on those channels.

As illustrated in FIG. 8B, if the responding device doesn't have CCA information for all channels, it may answer with a CTS frame transmission 706 (e.g., with or without CT) on at least the primary channel, indicating that the RTS frame transmission 408 was received, but CCA is not fully available (e.g., the CTS frame transmission 706 is not final). The initiating device may therefore defer a data transmission 406 for some timeout period to receive a second CTS frame transmission 708, which may include an indication that the CTS frame transmission 708 is final (e.g., last CTS transmission in response to the RTS frame transmission 408).

For example, the responding device, after sending the first CTS frame transmission 706, may open its receiver to all requested channels and may monitor them (e.g., perform CCA on all channels). After PIFS interval, plus some slack (e.g., about 1 usec), the responding device may send the second CTS frame transmission 708 (e.g., the final (last) CTS) on all channels that it had been asked by the RTS frame transmission 408 and are free according to the CCA. The second CTS frame transmission 708 may indicate that they are final based on which the initiating device can begin data transmission (e.g., after a SIFS interval).

The techniques provided herein support efficient RTS frame and CTS frame communication and allow the responding device to listen on a primary channel and have little to no overhead if the responding device has CCA already measured. In certain aspects, the maximum time for responding to an RTS frame with a CTS frame may be slightly more than PIFS due to switching time (e.g., less than 1 usec).

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 500 illustrated in FIG. 5 may correspond to means 500A illustrated in FIG. 5A and operations 600 illustrated in FIG. 6 may correspond to means 600A illustrated in FIG. 6A.

For example, means for transmitting may comprise a transmitter (e.g., the transmitter unit 222) and/or an antenna(s) 224 of the access point 110 or the transmitter unit 254 and/or antenna(s) 252 of the user terminal 120 illustrated in FIG. 2. Means for receiving (or means for obtaining) may comprise a receiver (e.g., the receiver unit 222) and/or an antenna(s) 224 of the access point 110 or the receiver unit 254 and/or antenna(s) 254 of the user terminal 120 illustrated in FIG. 2. Means for processing, means for generating, means for performing, means for deferring or means for determining, may comprise a processing system, which may include one or more processors, such as the RX data processor 242, the TX data processor 210, the TX spatial processor 220, and/or the controller 230 of the access point 110 or the RX data processor 270, the TX data processor 288, the TX spatial processor 290, and/or the controller 280 of the user terminal 120 illustrated in FIG. 2. Means for outputting may be a transmitter or may be a bus interface, for example, to output a frame from a processor to an RF front end for transmission.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. In addition, as used herein, communicating refers to receiving, transmitting, or both receiving and transmitting.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communication, comprising:
a first interface configured to obtain a first frame on at least one channel;
a processing system configured to:
perform an assessment on the at least one channel;
generate a second frame after obtaining the first frame; and
determine a transmission time of the second frame based on results of the assessment; and
a second interface configured to output the second frame for transmission on the at least one channel according to the determined transmission time.

2. The apparatus of claim 1, wherein the first frame comprises a request-to-send (RTS) frame, and the second frame comprises a clear-to-send (CTS) frame.

3. The apparatus of claim 1, wherein the at least one channel comprises a plurality of channels.

4. The apparatus of claim 1, wherein the second frame comprises an indication that the transmission of the second frame is a last transmission in response to the first frame.

5. The apparatus of claim 1, wherein the second interface is configured to output the second frame for transmission after the first frame is obtained and at an end of a short interframe space (SIFS) interval or a point coordination function (PCF) Interframe Space (PIFS) interval, wherein the SIFS interval and the PIFS interval begin when the first frame is obtained.

6. The apparatus of claim 1, wherein the at least one channel comprises a primary channel.

7. The apparatus of claim 1, wherein:
the processing system is further configured to generate a third frame after the first frame is obtained;
the second interface is further configured to output the third frame for transmission to another apparatus on the at least one channel; and
the second interface is configured to output the second frame for transmission after outputting the third frame for transmission.

8. The apparatus of claim 7, wherein the third frame comprises a clear-to-send (CTS) frame.

9. The apparatus of claim 7, wherein the second interface is configured to output the third frame for transmission after the first frame is obtained and at an end of a short interframe space (SIFS) interval, wherein the SIFS interval begins when the first frame is obtained.

10. The apparatus of claim 7, wherein the second interface is configured to output the second frame for transmission at an end of a point coordination function (PCF) Interframe Space (PIFS) interval, wherein the PIFS interval begins when the third frame is outputted for transmission.

11. An apparatus for wireless communication, comprising:
a processing system configured to generate a first frame;
a first interface configured to output the first frame for transmission on at least one channel; and
a second interface configured obtain a second frame on the at least one channel after outputting the first frame, wherein:
the processing system is further configured to:
determine whether the second frame comprises an indication that the second frame is a last transmission in response to the first frame; and
defer outputting data for transmission based on the determination.

12. The apparatus of claim 11, wherein:
the first frame comprises a request-to-send (RTS) frame; and
the second frame comprises a clear-to-send (CTS) frame.

13. The apparatus of claim 11, wherein:
the first interface is configured to obtain a third frame after outputting the first frame if the second frame is not a last transmission in response to the first frame.

14. The apparatus of claim 13, wherein the third frame comprises a clear-to-send (CTS) frame.

15. The apparatus of claim 13, wherein the third frame is obtained after the second frame is obtained and at an end of a point coordination function (PCF) Interframe Space (PIFS) interval, wherein the PIFS interval begins when the second frame is obtained.

16. The apparatus of claim 13, wherein the first interface is configured to output the data for transmission after the third frame is obtained and after a short interframe space (SIFS) interval.

17. The apparatus of claim 13, wherein the third frame is obtained via a plurality of channels.

18-53. (canceled)

54. A wireless node, comprising:
at least one antenna;
a receiver configured to receive, via the at least one antenna, a first frame on at least one channel;
a processing system configured to:
perform an assessment on the at least one channel;
generate a second frame after receiving the first frame; and
determine a transmission time of the second frame based on results of the assessment; and
a transmitter configured transmit the second frame on the at least one channel according to the determined transmission time.

55. The apparatus of claim 11, further comprising at least one antenna, wherein the first interface is configured to output the first frame for transmission via the at least one antenna, wherein the second interface is configured to obtain the second frame via the at least one antenna, and wherein the apparatus is configured as a wireless node.
